(19) United States
(12) Patent Application Publication
(10) Pub. No.: US 2005/0068191 A1
(43) Pub. Date: Mar. 31, 2005

(54) Remote-controllable central control device

(76) Inventors: Bernd Eschke, Bad Salzdetfurth (DE); Joerg Fischer, Hildesheim (DE); Hans-Joerg Mathony, Tamm-Hohenstange (DE); Doerte Eimers-Klose, Reutlingen (DE); Klaus-Michael Mayer, Ditzingen (DE); Dirk Hoheisel, Reutlingen (DE); Alfred Kizler, Korntal-Muenchingen (DE); Rainer Lust, Sindelfingen (DE); Roland Ehniss, Bad Liebenzell (DE); Bernd Flick, Diekholzen (DE); Jan Egelhaaf, Leonberg (DE); Hartmut Becker, Wiersheim (DE)

Correspondence Address: Richard L Mayer;Kenyon & Kenyon, One Broadway, New York, NY, 10004, US

(21) Appl. No.: 10/489,447

(22) PCT Filed: Aug. 24, 2002
(86) PCT No.: PCT/DE02/03118

(30) Foreign Application Priority Data
Sep. 11, 2001 (DE) 101 44 780.9

(51) Int. Cl. G08C 19/00

(52) U.S. Cl. 340/825.72; 340/5.74; 345/169; 307/10.1; 455/99; 340/426.13

(57) ABSTRACT

A control device in a vehicle is used for controlling a plurality of vehicle functions. An air interface is provided, via which the control device in the vehicle may be accessed from an input device.

### BACKGROUND INFORMATION

Motor vehicles are known in which control units for vehicle functions and for multimedia applications in cars, such as, for example, car radio, TV, or navigational applications, are interconnected via different bus systems. External units, such as a mobile telephone, or a portable pocket computer, a PDA (personal digital assistant) for example, are connected to the existing driver information system. There is no linkage between the vehicle electronics, i.e., electronics, which includes the driving characteristics, the driving conditions, and the vehicle control, and the external units. Thus, reliable external control and/or interrogation of the vehicle electronics is/are impossible. In addition, it is impossible or very costly to upgrade systems once installed in the vehicle since they have no external interfaces. The vehicle electronics, the display unit in particular, which is relevant for the driver's safety in particular, cannot resort to external resources.

### SUMMARY OF THE INVENTION

The control device according to the present invention has the advantage over the related art in that vehicle function devices and/or the output units in the vehicle are controllable via the air interface using the input device. By accessing the vehicle function devices, e.g., control circuits for the engine control, the fuel supply, the brake system, or the cooling system, this makes it possible to perform remote diagnosis and remote maintenance of these systems. The vehicle may be checked and serviced by the manufacturer or an assigned facility without intervention by the user and may, if needed, be summoned into a repair shop. Moreover, a climate control system may be controlled via the input device, a desired temperature being set before the trip, so that the passenger compartment has the desired temperature when the vehicle is entered. Furthermore, the output units in the vehicle may also be controlled via the input device. Output units are, for example, a radio device, a vehicle navigation system, or an Internet access. For example, a destination, a route to which is to be computed by the navigation system, may be transmitted from the input device to the navigation system via the air interface.

It is advantageous in particular to connect the control device to a plurality of vehicle bus systems. Such bus systems are in general adapted to the particular application with regard to their data throughput and their transportation safety, so that a suitable connection from the input device is implementable using the control device and the bus system connected to it. The control device also enables the bus systems to exchange data among each other.

Furthermore, it is advantageous to check instructions transmitted to the control device regarding an identification of the input device and to allow access to vehicle systems only against unambiguous identification and authorization depending on the vehicle system. If, for example, a telephone call from a transmitter of a mobile network operator is picked up via the air interface, the call is then relayed to suitable output devices in the vehicle, so that the driver is able to establish a telephone connection. Other vehicle systems, however, remain blocked for any caller. If, however, the vehicle manufacturer identifies himself, certain vehicle data may be made available to the vehicle manufacturer, so that vehicle systems may be checked and the vehicle user may be referred to a possibly necessary service. The access rights advantageously also depend on the vehicle condition. For example, safety-relevant systems may be accessed only in the parked position with the engine switched off so that driving safety is not jeopardized. Test functions such as a brake test, for example, may also be actively carried out during such an access. A user is advantageously identified via a non-volatile memory in which it is specified, for each bus system and/or for each bus system function, which bus system or which function may be accessed by an external input device, depending on its identification.

Furthermore, it is advantageous to locate the air interface in a first display unit in a motor vehicle. The control device may advantageously also be integrated into the first display unit so that electric components may be installed into the vehicle, preferably combined in one housing.

Furthermore, it is advantageous to provide a first and a second control device, the first control device being assigned to the output units and the second control device being assigned to the vehicle functions. While the first control device is protected by a first firewall, the second control device is additionally protected by a second firewall, so that an input device, which receives permission to access the first control device, e.g., from a service provider for a vehicle navigation function executed outside the vehicle in a central office, is refused access to the second control device. Nevertheless, a repair shop and/or a vehicle manufacturer may access safety-relevant vehicle systems via the air interface, provided a successful identification takes place at the second firewall. The first and the second firewall are a manipulation safeguard which checks, at each access to the elements behind it, whether the particular accessor is authorized for the access.

Furthermore, it is advantageous to connect a dedicated display unit to the first control device and to the second control device. This makes it possible to separate the display of data of the output units from the display of data directly relevant to the trip, such as, for example, the vehicle speed or the malfunction of relevant vehicle systems.

Furthermore, it is advantageous to install units which are connectable to the control device via a data bus in a module area which preferably has a standardized module bay. This makes it possible to expand the control device as desired. Operating elements otherwise connected to the control device may also be used for operating the additional units installed in the module area.

It is particularly advantageous to design the additional units and/or modules in the form of plug-in cards which are inserted into a suitable box. A box for inserting plug-in cards should be situated at a suitable, preferably accessible, but non-interfering location in the vehicle, whereby housings for individual units may be saved. At the same time, a display unit and an operating element of other units may also be used for the retrofitted units. Replacement of plug-in cards is possible in a simple manner, thus allowing for a simple add-on of additional units and an easy exchange of existing units.

A particularly simple operation is achieved in that operating elements for units and functions which are controllable via the control device are situated on a steering wheel in the vehicle, making them easily reachable for the driver.

Furthermore, it is advantageous that vehicle data is also retrievable via the air interface which allows external vehicle diagnosis, also by a service center in the event of a vehicle defect, for example.

Furthermore, it is advantageous that the input device also has additional functions, e.g., an Internet function or a telephone function, as well as a schedule management function, which may be controlled via operating devices connected to the control device so that no input needs to be entered directly on the input device using impractical or small operating elements. Voice input of text or instructions is preferably also possible.

### BRIEF DESCRIPTION OF THE DRAWINGS

FIG. 1 shows a first exemplary embodiment of a control device according to the present invention in connection with vehicle systems in a motor vehicle.

FIG. 2 and FIG. 3 show further possible applications according to the present invention of a control device according to the present invention together with vehicle systems.

### DETAILED DESCRIPTION

The control device according to the present invention may be used in any vehicle. Its use is particularly advantageous in motor vehicles in which a plurality of electrical and mechanical systems must be controlled and serviced. By linking different individual systems, synergy effects between the individual systems may be utilized. For example, data of an odometer, which is analyzed for determining the vehicle speed, may also be available for vehicle navigation. Additional connections between individual systems in the vehicle may be avoided by using a central control device to which all systems are connected. This also creates a favorable extensibility since additional systems to be integrated into the vehicle may be connected to the control device, thereby being instantly interconnected with all other systems. A high degree of security is achieved by an access control via which authorization of the input device to access different vehicle systems is checked.

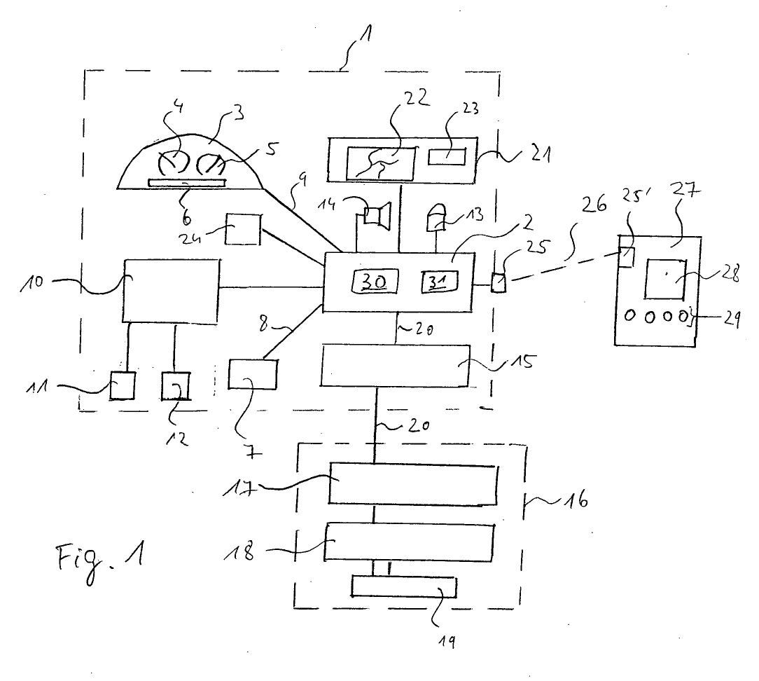

A first exemplary embodiment for a control device and the associated vehicle electronics in a motor vehicle is illustrated in FIG. 1. A control device 2, used as a main component of the vehicle electronics for interconnecting data of vehicle-specific systems and optional output units, e.g., multimedia units and data communication units, is situated in a main area 1 of the vehicle electronics, delimited in FIG. 1 by a dashed line. In the event of data output by different units within a short time interval, the control device controls and prioritizes the data flow between the individual components connected to it. The interfaces of the control device are standardized, the communication with the connected components taking place via suitable bus systems. A first display unit 3 for indicating vehicle-specific variables is connected to control device 2. The vehicle-specific variables are displayed in a first scale display unit 4, in a second scale display unit 5, and/or in an additional display unit 6, for example, the additional display unit 6 in particular serving for the display of warning fields or error messages. First display unit 3 is situated in the dashboard in front of the driver. Control device 2 is preferably situated behind the dashboard cover, at a location not directly accessible by the vehicle's passengers. The vehicle data, indicated in first display unit 3, is conveyed from vehicle sensors 7 to control device 2 via a CAN bus connection 8 and then transmitted from control device 2 to first display unit 3 (CAN=Controller Area Network). Other suitable bus connections are also possible instead of a CAN bus connection. In a further embodiment, sensors may be directly connected to first display unit 3 via CAN bus connection 9. In addition, control device 2 is connected to a central signal and power distribution unit 10 to which in turn actuators 11 in the vehicle and an operating unit 12 are connected, the operating elements of operating unit 12 being situated next to a driver's seat. The operating elements are preferably situated on the steering column or the steering wheel of the vehicle. In addition, a microphone 13 and a loudspeaker 14 are connected to control device 2. Voice control of the systems connected to control device 2 is made possible via microphone 13. Feedback about inputs entered and warning information may be output via loudspeaker 14. In addition, loudspeaker 14 and microphone 13 may also be used as components of a telephone device, a telephone connection being established via air interface 25. In a case of emergency, an emergency signal, which is transmitted to a control center via the air interface, may be triggered either automatically or by a driver. The current vehicle location may be included in the transmission via the navigational function of a navigation device connected to the control device.

In addition, control device 2 is connected to an operating device 15 on the center console via which units, situated in a second electronics unit 16, are operatable. Second electronics unit 16 is preferably situated in the vehicle's center console and features standardized module bays, for output units in particular. In the present embodiment, a radio reception and music playback device 17, a navigation device 18, and a drive 19 are situated in second electronics unit 16. Second electronics unit 16 is preferably connected to main area 1 and thus to control device 2 via an optical data bus 20. In addition, control device 2 is connected to a second display unit 21 in which, among other things, a map display 22 of a vehicle navigation system and text information, e.g., about a tuned-in radio station of radio reception and music playback device 17, may be displayed. Drive 19 is preferably designed as a CD drive; it may, however, also be used for any memory cards or magnetic tape, as well as for other magnetic and/or optical data media. In addition, control device 2 is connected to an access control 24 which controls access to the vehicle, i.e., a locking system in the vehicle, an alarm system, and/or an anti-theft device.

Control device 2 is connected to an air interface 25 via which a wireless connection 26 with an external input device 27 may be established. In another embodiment, an optical connection, via infrared or laser light, for example, is also possible instead of wireless connection 26. Input device 27 has preferably a display unit 28 and operating elements 29. In a first exemplary embodiment, input device 27 is designed as a portable computer, e.g., a notebook or a PDA (Personal Digital Assistant), or as a mobile telephone. In another exemplary embodiment, the input device may also be an external computer device which makes contact with air interface 25 and thus with control device 2 via a mobile wireless connection. Using operating elements 29, a user may now transmit a command, which is preferably displayed in display unit 28, from input device 27 to control device 2 via wireless connection 26 and air interface 25. A mating component 25′ to the air interface, situated in main area 1 and connected to control device 2, is provided in input device 27. Control device 2 has a processor 31 which records the command which has been transmitted, and which in addition requests an identification from input device 27 or checks an identification transmitted together with the command. For this purpose, control device 2 has a non-volatile memory 30 in which authorizations, assigned to certain identifications for access to vehicle functions, are stored. Stored in non-volatile memory 30 is the information in particular identifying the devices connected to control device 2 which may be accessed by a user from input device 27. Access to individual bus systems is controlled in particular. Access to a navigation device 18, for example, via which the current vehicle location is retrieved and re-transmitted to input device 27, may be possible for a certain identification. Since the current vehicle location is available, this is of particular interest for a trucking company or a taxi company in order to plan an optimum routing system for a vehicle fleet; data about a vehicle condition may also be transmitted.

Checking of vehicle functions, actuators 11 in particular, is additionally possible. Vehicle functions, e.g., oil level, brake fluid level, or coolant level, or the operational capability of vehicle modules such as the brake system, for example, may be specifically checked by an authorized repair shop. In the event of a defect disabling a vehicle, it is possible to quickly convey repair advice to the driver or a technician, or to prepare for repair in the shop itself. In addition, routine checks or software updates of programs stored in the control units of the vehicle may be performed by the vehicle manufacturer or an authorized service provider. In a preferred exemplary embodiment, certain actuator systems of control device 2 may be accessed by input device 27 only when the vehicle is parked or the engine is switched off. A possibly hazardous intervention in safety-relevant systems while driving is thereby made impossible. The priority of input commands is advantageously taken into account by control device 2, so that commands input by a driver via the operating device 15 in the center console have preference over those input via input device 27. Generally, processing of queries of safety-relevant vehicle systems, the brake system, for example, has priority over other tasks of the control device. In the case of an emergency, processing of a current query is aborted in favor of the request of the safety-relevant system. A priority regulation in this regard is preferably stored in non-volatile memory 30 of control device 2.

The control device may be used in a plurality of vehicles if it is adapted to the particular vehicle functions. Using the operating device 15 in the center console, it is also possible to access input device 27 and to either transmit replies to input device 27 or to control input device 27. In a first exemplary embodiment, input device 27 is used in the proximity of the vehicle, e.g., by a repair shop, to perform data communication with the vehicle. In addition, however, communication may also take place from any distance via a mobile wireless connection. Attaching an additional telephone connection in the vehicle may thus be avoided. At the same time, the telephone connection may also be used to connect to input device 27.

In a further exemplary embodiment, the control device may be used for controlling an air conditioning system (not shown in FIG. 1). A vehicle temperature may be pre-selected using the input device so that, prior to entering the vehicle, this vehicle temperature is already set by the climate control, either by heating or cooling. Moreover, the vehicle lighting may be switched via the input device so that, in a large, unlighted parking lot, a driver may easily find his vehicle by triggering the vehicle lighting. By monitoring the vehicle functions using one's own input device, the driver may always check the operational capability of his vehicle by himself. The connection to input device 27, which may also be a user's computer, makes vehicle navigation, i.e., steering the vehicle in a road network, possible via the user's computer on which a route is mapped out and then transmitted to the vehicle. Navigation information services, for example, may also access the navigation device in order to transmit current traffic data. Other functions remain blocked for the provider of the navigation information.

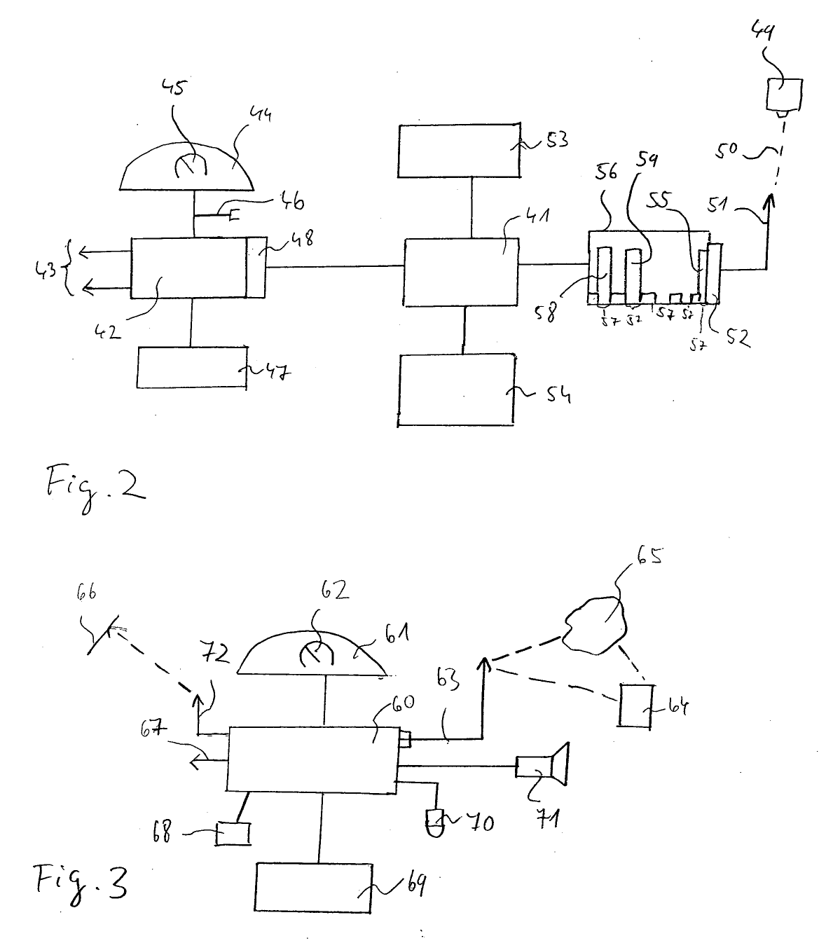

FIG. 2 shows a further exemplary embodiment of a control device connected to vehicle electronics. A first control device 41 for controlling output units and an operating interface are provided here. Preferably only such systems are connected to first control device 41 which are irrelevant for driving safety. A second control device 42 is additionally provided which is connected to vehicle sensors and actuators in the vehicle, e.g., the brake system or the engine control, via bus system 43, preferably CAN bus systems. Furthermore, second control device 42 is connected to a second display unit 44 having displays 45 for displaying vehicle variables using preferably at least one pointer device. A diagnostic connector 46, via which, by connecting an external unit, the functions of the bus systems and second control device 42 may be directly accessed, is preferably situated at the bus connection to second display unit 44.

The vehicle functions are controlled via operating elements 47 which are connected to second control device 2. Operating elements 47 are preferably situated on the steering wheel, on a steering column, or in the floor area in front of a driver of the vehicle. Second control device 42 is protected vis-à-vis first control device 41 by a second firewall 48. Second firewall 48 is used as a manipulation safeguard and allows access from first control device 41 to the second control device only for commands which are issued by an authorized source, the authorization being dependent on the vehicle condition. Second control device 42 may be accessed by first control device 41 and also via an external input device 49, via a wireless connection 50, and via an air interface 51 connected to first control device 41. A first firewall 52, which already checks an access of input device 49 to first control device 41 and denies access when an authorization turns out to be negative, is preferably situated between air interface 51 and first control device 41. An additional display unit 53, situated preferably in the center console of the vehicle, is preferably connected to the first control device. Moreover, additional operating elements 54 are likewise preferably situated in the center console.

A control of first air interface 51 is preferably situated on a plug-in card which is inserted into a plug-in card housing 56. Plug-in card housing 56 has plug-in card slots 57 into which electric circuits situated on a printed board may be inserted into a designated connector. In this way, additional units may be connected to first control device 41. In the present exemplary embodiment, a radio device 58 and a navigation device 59, each situated on its own plug-in card, are inserted into designated plug-in connections of plug-in card slots 57. This makes it possible to easily exchange or expand modules which are connected to first control device 41. Such modules are, for example, a television receiver, a satellite receiver, a radio amplifier, an additional air interface, an interface to a camera, or a particular drive. A data connection between plug-in card housing 56 and first control device 41 is preferably designed as a fire wire bus (IEEE1394B). In a preferred exemplary embodiment, the modules are automatically identified by first control device 41 after having been inserted so that initialization by the user is not necessary. Likewise, as in the exemplary embodiment according to FIG. 1, external access to the vehicle electronics from input device 49 is possible.

In the event of theft of a vehicle, it is also possible to act upon vehicle functions via air interface 51. An electric anti-theft device may be triggered and the current vehicle location may be retrieved, among other things.

GSM, GPRS, or UTMS, for example, are possible as transmission modes for mobile wireless transmission. Connection to an external service provider, or to an emergency control center, as well as to a vehicle manufacturer or a repair shop, may also be established in such a way that a wireless connection to an input device is initially established via the air interface, a Bluetooth interface for example. The input device has in turn a mobile wireless module via which a connection to a remote unit outside the vehicle may be established via a mobile wireless connection. In a further exemplary embodiment, an additional mobile wireless module may be inserted into a plug-in card connector. This makes it possible to establish a connection from the input device to the mobile wireless module via the interface which enables a wireless connection, via a Bluetooth interface, for example, and then a connection from the mobile wireless module to a service provider via a data network. These possibilities arise in a similar manner for the exemplary embodiments according to FIGS. 1 and 3.

Components for additional output units in the vehicle may also be inserted into the plug-in card connectors, for screens situated in a backrest of the vehicle, for example. Furthermore, it is also possible to provide a plug-in card for controlling a touch screen displayed in display unit 53 via operating elements 54, so that this touch screen may be updated and adapted to newly connected units.

A further exemplary embodiment in which a display unit 61 for the display of vehicle data, via a scale display unit 62 and/or a liquid-crystal display, for example, and an air interface 63 for a connection to an input device 64 or to a data network 65 are situated on a control unit, is shown in FIG. 3 in a simplified form. A GPS receiver 72 for establishing a wireless connection to a satellite 66 of a satellite identification system is preferably connected to control device 60 for determining the location. Control device 60 may access vehicle functions and sensors 68 via data buses 67. The devices are preferably operated via operating elements 69 situated on the steering wheel. Voice control takes place via a microphone 70 and radio information, traffic advice, or warning announcements are output via a loudspeaker 71. All units for the control and monitoring of the access via the air interface are provided in control device 60. Control device 60 is preferably integrated into a housing of display unit 61, so that no additional housing components for control device 60 are needed. Air interface 63 is also situated in display unit 61 which is preferably designed as a combination instrument for showing a plurality of displays in the vehicle. It is also possible to integrate microphone 70 and loudspeaker 71 into display unit 61. Furthermore, output is also possible via loudspeakers of a car radio which is to be additionally provided in the vehicle. User identification preferably takes place via a card reader into which a memory card is inserted. Voice control preferably takes place where texts, for creating e-mails, for example, may be input. In a preferred exemplary embodiment, a telephone function and a short message transmission function are also integrated into control device 60.

1-12. (canceled)

13. A control device in a vehicle for controlling at least one of (a) vehicle function devices and (b) output units in the vehicle, the control device being connected to an input device via an air interface, the control device being connected to a plurality of vehicle bus systems, the control device comprising:
a first arrangement for exchanging data between the vehicle bus systems;
a second arrangement for controlling, via the input device, at least one of (a) the vehicle function devices and (b) the output units in the vehicle; and
a third arrangement for performing a check to determine which of the vehicle bus systems the input device is permitted to access as a function of an identification transmitted by the input device.

14. The control device according to claim 13, further comprising a fourth arrangement for performing a check to determine which functions controllable via a bus system the input device is permitted to access as a function of an identification transmitted by the input device.

15. The control device according to claim 13, further comprising a non-volatile memory for storing information establishing under which conditions which bus system and which functions, callable via a bus system, may be accessed.

16. The control device according to claim 13, wherein the air interface is situated on a display unit.

17. The control device according to claim 13, further comprising first and second control devices, a first firewall being connected between the air interface and the first control device, a second firewall being connected between the first control device and the second control device, the output units being connected to the first control device, the vehicle function devices being connected to the second control device.

18. The control device according to claim 17, wherein a first display unit is connected to the first control device, and a second display unit is connected to the second control device, vehicle data being displayable in the second display unit, data of the output units being displayable in the first display unit.

19. The control device according to claim 13, wherein the output units are mounted in a mounting area and are connected to the control device.

20. The control device according to claim 19, wherein a connector device for attaching plug-in cards is situated in the vehicle, the plug-in cards being connectable to the control device.

21. The control device according to claim 13, wherein the control device is operator-controllable via operating elements situated in a steering wheel of the vehicle.

22. The control device according to claim 13, wherein vehicle data is callable via the air interface.

23. The control device according to claim 22, wherein a control of the air interface is situated on a plug-in card in a plug-in card housing.

24. The control device according to claim 13, wherein the input device has additional functions, and the additional functions are controllable via an operating unit connected to the control device.
